(19) United States
(12) Patent Application Publication
(10) Pub. No.: US 2022/0373502 A1
(43) Pub. Date: Nov. 24, 2022

(54) HIGH PRESSURE SINGLE-USE ELECTROCHEMICAL ANALYTICAL SENSOR

(71) Applicant: Rosemount Inc, Shakopee, MN (US)

(72) Inventors: Andrew S. DIERKER, Minnetonka, MN (US); Tyrel L. Ruch, Saint Paul, MN (US); Chad M. McGuire, Shakopee, MN (US); Jinbo Hu, Minnetonka, MN (US); Rick J. Sumrall, Eden Prairie, MN (US); Taufiq Ahmed, Apple Valley, MN (US)

(21) Appl. No.: 17/749,619

(22) Filed: May 20, 2022

Related U.S. Application Data
(60) Provisional application No. 63/191,608, filed on May 21, 2021.

(51) Int. Cl. G01N 27/403; G01N 27/30

(52) U.S. Cl. CPC G01N 27/4035; G01N 27/301

(57) ABSTRACT

A single-use electrochemical analytical sensor is provided. The sensor includes a sensing electrode configured to contact process fluid and a reference chamber containing an electrolyte. A reference electrode is disposed in the electrolyte. A reference junction is configured to contact the process fluid and is further configured to generate a flow of electrolyte into the process fluid. The reference chamber is configured to be stored in a depressurized state and then pressurized prior to operation. A method of operating a single-use electrochemical sensor is also provided.

### CROSS-REFERENCE TO RELATED APPLICATIONS

The present application is based on and claims the benefit of U.S. Provisional Patent Application Ser. No. 63/191,608 filed May 21, 2021; the content of which application is hereby incorporated by reference in its entirety.

### BACKGROUND

During the past two decades, single-use or disposable bioprocessing systems have gained significant momentum to replace stainless-steel systems in biopharma manufacturing. In contrast to the conventional systems that are constructed with stainless-steel equipment, single-use systems rely on highly-engineered polymers and come pre-sterilized via gamma irradiation. For end users, they offer several significant advantages including reduced initial investment, elimination of complex processes of pre-cleaning, sterilization, and validation, as well as improved process turnaround time. As a result, single-use bioprocessing systems have been adopted from initial R&D laboratories to large-scale commercial pharmaceutical manufacturing on an accelerated pace.

pH is a critical process parameter in many processes of biopharma manufacturing. In upstream bioreactor applications, medium culture pH is continuously monitored and controlled within a narrow physiological range and deviation from this ideal pH range can negatively affect viable cell concentration, protein productivity and quality. Traditional pH sensors used in biopharma manufacturing are based on electrochemical measurement methods with a pH sensitive glass electrode and a reference electrode. Due to its high reliability, accuracy, and stability, this is a well-established technology with proven success in biotechnology and pharmaceutical industries.

Conventional pH sensors, however, are designed to be compatible with conventional stainless-steel style bioreactor systems and therefore have several significant limitations when used in single-use systems. First, conventional sensors must be sterilized by the end user using autoclaving, steam-in-place, or clean-in-place procedures. They are generally not compatible with gamma irradiation sterilization process as gamma irradiation could damage their sensing components and lead to undesired performance degradation. To ensure satisfactory accuracy, conventional pH sensors usually require a two-point calibration conducted by end users prior to use, which is cumbersome and adds to complexity in the process. Furthermore, conventional pH sensors usually have a one-year shelf life because the pH sensing glass will age over time, leading to reduced sensor performance. Unfortunately for single-use systems, longer sensor shelf life is greatly preferred as the sensor could be attached to a plastic bioreactor bag as one single assembly or in a tube set for downstream applications with an expectation of a much longer shelf life.

### SUMMARY

A single-use electrochemical analytical sensor is provided. The sensor includes a sensing electrode configured to contact process fluid and a reference chamber containing an electrolyte. A reference electrode is disposed in the electrolyte. A reference junction is configured to contact the process fluid and is further configured to generate a flow of electrolyte into the process fluid. The reference chamber is configured to be stored in a depressurized state and then pressurized prior to operation. A method of operating a single-use electrochemical sensor is also provided.

### BRIEF DESCRIPTION OF THE DRAWINGS

FIGS. 1A and 1B are a diagrammatic view of a pH sensor for low pressure bioreactor applications illustrating a storage position as well as an operation position, respectively.

FIG. 2 is a chart illustrating reference chamber pressure decay over time for a pH sensor.

FIGS. 3A and 3B are diagrammatic views of a pH sensor for downstream applications in accordance with one embodiment.

FIG. 4 is a flow diagram of a method of operating a single-use electrochemical analytical sensor in accordance with one embodiment.

### DETAILED DESCRIPTION OF ILLUSTRATIVE EMBODIMENTS

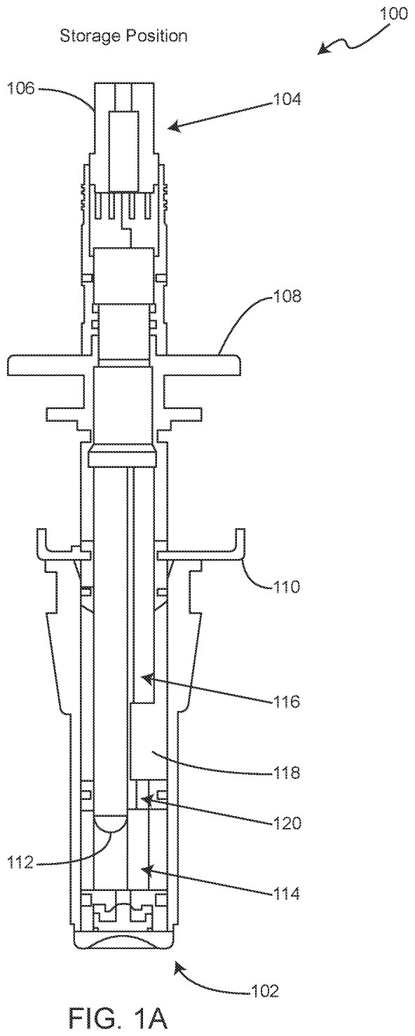

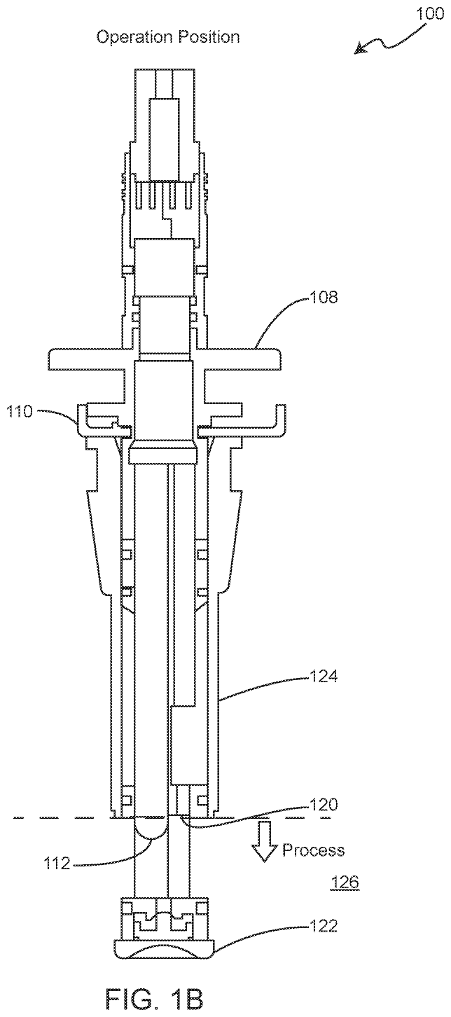

FIGS. 1A and 1B are diagrammatic views of a pH sensor for low pressure (i.e., upstream) bioreactor applications illustrating a storage position as well as an operation position, respectively. Suppliers of single use instrumentation typically assemble the pH sensor into a tube set and gamma irradiate that assembly to sterilize it. It is desirable for such sensors to have a 2-year shelf life for this assembly so the supply chain can be efficiently managed and provide users with a reasonable shelf life. When pressurizing the reference chamber at the time of sensor manufacture, any loss of fluid in this small sealed volume significantly reduces the pressure.

FIG. 1A is a diagrammatic view of a pH sensor illustrating a storage position. In the illustrated example, the pH sensor is generally shown in cross section having a distal end 102 that is generally configured to engage a process, such as a bioreactor bag, and a proximal end 104 having an electrical connector 106 that is configured to couple to instrumentation. One example of connector 106 is known as a Variopin connectors.

Some electrochemical analytic sensors are considered amperometric in that they generate a current indicative of the process variable, such as pH. Other types of sensors, are considered potentiometric sensors, since they generate a potential that indicates the process variable. As used herein, electrochemical analytic sensors are intended to include any analytical sensor that has an electrical characteristic that varies with the process variable.

Sensor 100, as shown in FIG. 1A, is provided in a storage position configuration, in which process plunger 108 is spaced from locking member 110. When in the storage configuration, pH sensing glass electrode 112 is maintained within storage chamber 114 which is filled with a buffer solution. As can be seen in FIG. 1A, a reference electrode 116 is provided within electrolyte 118, which electrolyte 118 is configured to electrically couple to a process via reference junction 120. Sensor 100 is maintained in the storage position for both storage, and calibration just prior to operation. This is because the buffer solution in storage chamber 114 has a known pH, and the sensor can be calibrated, or otherwise characterized, by measuring the pH with electrode 112 and comparing the measured value against the known pH of the buffer solution.

FIG. 1B is a diagrammatic view of pH sensor 100 illustrating an operation position. Contrasting FIGS. 1B and 1A, shows that process plunger 108 has been slid to be proximate locking member 110. This sliding motion has caused end 122 to extend from side wall 124 thereby exposing pH glass electrode 112 to process 126. As can be seen, process 126 is also exposed to reference junction 120. Thus, the sliding motion from the storage position to the operation position, has exposed the wet storage chamber 114 to process 126. In the configuration shown in FIG. 1B, sensor 100 may be used to sense the pH of process fluid, such as a bioreaction fluid, a cell culture or mash.

As shown in FIGS. 1A and 1B, the illustrated sensor provides wet storage for the pH glass and reference junction via a separate storage chamber and sliding sensor assembly that is moved axially within the process connector and into the process upon startup. The sliding sensor assembly provides a reliable measurement at low process pressures. Note, the process connector sleeve remains fixed relative to the process media and the sensor is moved when inserted into the process.

The single-use pH sensor is compatible with gamma irradiation sterilization and can be attached to a single-use bioreactor bag to form one assembly. With the incorporation of a unique storage buffer solution, the sensor does not require a two-point calibration by end users and can be one-point standardized using this storage buffer solution. More importantly, the storage buffer solution is in contact with the pH and reference electrodes keeping them wet and fresh while the sensor is stored. This wet storage has led to a long shelf life of 2 years with outstanding sensor performance including high accuracy, sensitivity, and stability. Through rigorous real-time testing with prototypes that were not aged, 1-year aged and 2-year aged, it was demonstrated that the sensor performance remains at a high level without degradation after 2 years of storage.

After the cell culture process is complete in the bioreactor bag, the media is moved to the downstream part of the process. Here the media is pushed through filtration phases in small line size tubing at higher pressures of up to 90 psi. This higher process pressure may create problems with traditional pH sensors. A traditional glass electrode pH sensor has a reference junction that is a restricted path to connect the sensor's reference chamber, and the electrolyte buffer solution in it, to the process. An example of this junction is a porous ceramic cylinder placed between the reference chamber and the user's process. Another example is a polymeric junction. There must be positive ionic flow from the reference chamber of the sensor to the process fluid for the sensor to operate properly.

The higher process pressure of the downstream application can disrupt this ionic flow and causes the pH readings to fluctuate or drift. This disruption can be improved by pressurizing the reference chamber. However, previous methods for pressurizing a reference require pressurization with special methods at the factory. Because the reference junction is porous and the reference chamber is pressurized, the pressure decays over time and limits the shelf life and useful life of the sensor.

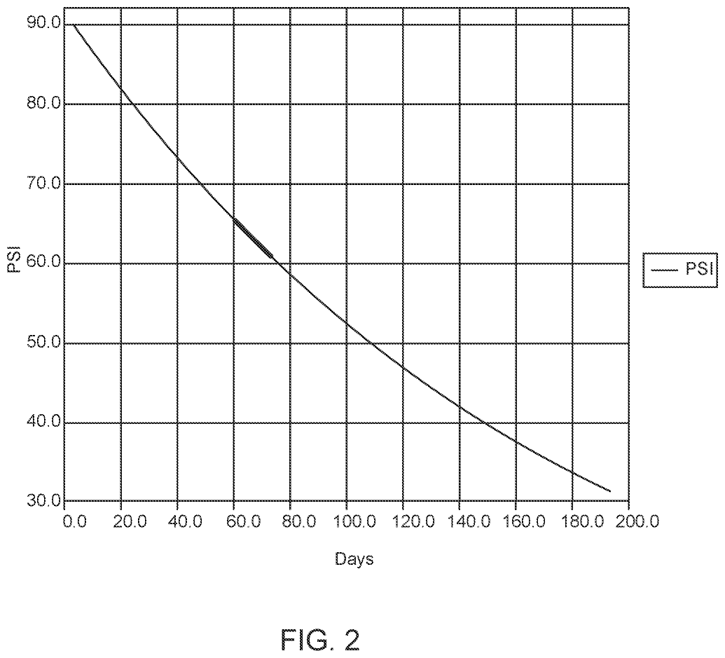

FIG. 2 is a chart illustrating reference pressure decay over time for a pH sensor. More particularly, FIG. 2 illustrates curve-fit data of reference pressure decay in modified commercially-available sensor (sealed junction, air filled)—data source: 14 days of pressure decay data at day 60. The data in FIG. 2 were curve fit and extrapolated −60 days to +180 days. Testing data in FIG. 2 has shown that possible shelf life is up to six months, assuming the sensor reference chamber is initially pressurized to 90 psi and a 30 psi minimum reference chamber pressure is required for the sensor to function properly. Additionally, once the sensor is moved to the “operating” position, the reference junction (porous material) is essentially a leak point and will allow the pressure to decay during use, limiting operating life. As set forth above, it is desirous to provide a downstream-compatible single-use pH sensor that has a viable shelf life as long as upstream sensors (2 years).

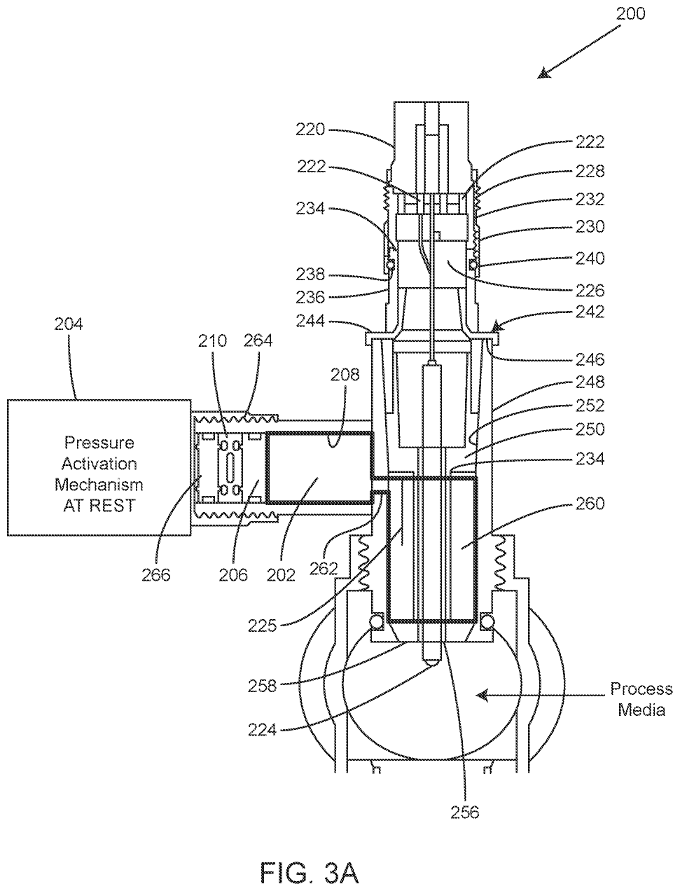

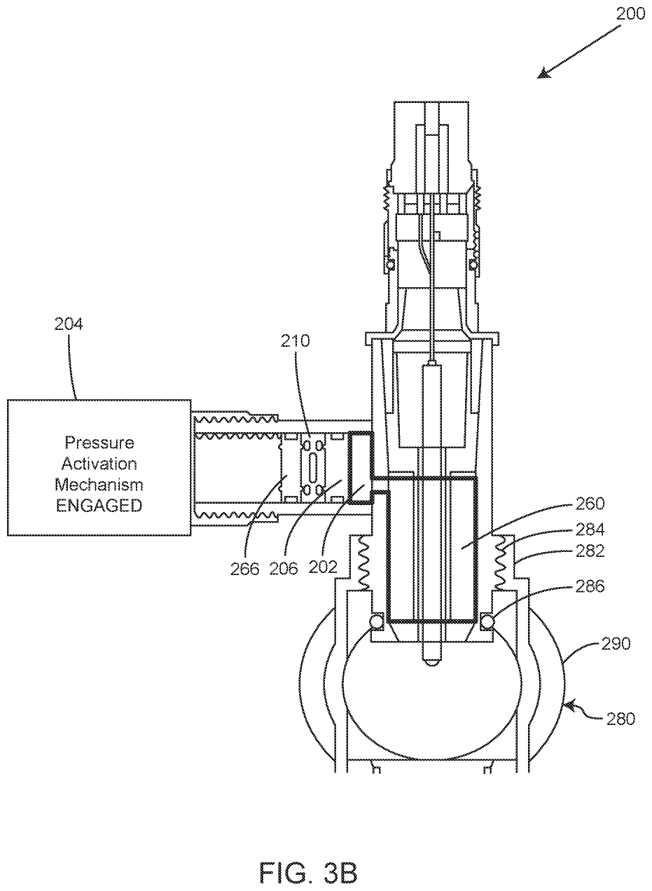

FIG. 3A is a diagrammatic view of a pH sensor for downstream applications in accordance with one embodiment. In the illustrated example, pH sensor 200 is provided with a reference chamber 202 that can be pressurized at the time of installation. This maximizes the shelf life of the unit because there is no differential pressure to drive reference fluid through the reference junction or the seals and thus lose pressure during storage. Instead, a user-actuatable mechanism 204 is used to generate the desired pressure in reference chamber 202. In one example, a piston 206 is depressed, or otherwise actuated, in cylinder 208 that is part of, or fluidically coupled to, reference chamber 202 to generate the desired pressure at the time of process start up. The force on piston 206 can be provided by compressing a spring 210 such as a wave spring to provide a near-constant pressure over time as the fluid in secondary reference chamber 202 is slowly pushed out through the porous reference junction. Other spring types can be used to provide constant pressure including using the expansion of the reference chamber itself under pressure as the potential energy source or compressing a gas in the chamber to act as the spring. This solves the shelf life problem as well as provides for a longer operating life.

FIG. 3A illustrates sensor 200 having an electrical connector 220 with a plurality of electrical contacts 222 therein. Contacts 222 are coupled to sensing elements within sensor 200, such as pH glass electrode 224 and reference electrode 225. Additionally, if additional sensing elements are employed in sensor 200, such as a temperature sensor and/or pressure sensor, contacts 222 facilitate electrical connection to such elements. Connector 220 may include any suitable features that facilitate cooperation with a mating connector, such as an externally threaded region 228. Connector 220 is preferably a sealed electrical connector such that internal cavity 226 is fluidically isolated from a cable or connector that coupled to connector 220. In one embodiment, connector 220 is a Variopin connector. Connector 220 is secured to sensor 200 by sleeve 230, which urges sidewall 232 into contact with end 234 of sidewall 236. Additionally, sidewall 236 preferably includes a groove 238 in which o-ring 240 is placed. Then, when sleeve 230 is threaded onto sidewall 232, an inner surface of sleeve 230 seals against o-ring 240.

Sidewall 236 is mounted or otherwise affixed to end 242 which includes a flange 244 that is sized to extend beyond and around end 246 of sidewall 248. End 242 may be constructed from the same polymer as sidewall 236 and/or sidewall 248 and may be affixed thereto by any suitable method including solvent welding, adhesive, ultrasonic welding, et cetera.

Sensor 200 also includes an insert 250 that contacts an internal diameter 252 of sidewall 248 and includes a center bore 254 that is sized to mount pH electrode 224 along a longitudinal axis of the sensor 200. Insert 250 also includes a sleeve 256 that runs along a length of pH electrode 224 and passes through an aperture in reference junction disc 258. Disc 258 can be a porous ceramic disc that is configured to release a controlled amount of electrolyte into the process over time. However, embodiments can be practiced where the reference junction has other types of physical configurations, such as a small conduit, or a plurality of such conduits.

Sidewall 248 defines a pair of references chambers 260, 202 as well as a conduit 262 fluidically coupling primary reference chamber 260 to secondary reference chamber 202. An at least partially fluidic electrolyte is disposed within reference chambers 260, 202. The electrolyte may be a liquid or a gel, but must have the ability to flow through reference junction 258 to some extent. As can be seen, by pressurizing secondary reference chamber 202, primary reference chamber 260 will also be pressurized. This pressurization help maintain flow of electrolyte out of the reference junction even when the process fluid pressure is elevated. In the configuration shown in FIG. 3A, a pressure activation mechanism 204 includes an internally threaded portion that is coupled to externally threaded portion 264 of sidewall 248. The pressure activation mechanism is shown in an at-rest configuration wherein piston 206 and piston 266 are adjacent pressure activation mechanism 204 and are disposed substantially within threaded portion 264.

FIG. 3B is a diagrammatic view of sensor 200 in a pressure-engaged configuration. Contrasting FIG. 3B with FIG. 3A shows that engagement of the pressure activation feature 204 has displaced pistons 266 and 206 toward electrode 224 thereby reducing the size of secondary reference 202 and pressurizing primary reference chamber 260. Additionally, in the illustrated configuration, both pistons 266 and 206 have been displaced the same distance. As the electrolyte slowly flows through reference junction 258, a pressure compensating mechanism, such as spring 210, will displace piston 206 away from the fixed, pressure-engaged position of piston 266. In this way, the pressure of primary reference chamber 260 will be maintained at the desired level until piston 206 bottoms out against sidewall 248. In one embodiment, sidewall 248, or a portion thereof, is formed of a transparent or translucent material, such that the position of piston 206 can be viewed by a user to assess the remaining pressure-compensating lifetime of the pressure compensation mechanism.

FIGS. 3A and 3B show sensor 200 coupled to a process adapter 280, which is configured to position sensing elements of the sensor within a process fluid. In the illustrated example, process adapter 280 includes an internally threaded sensor port 282 that is configured to receive external threads 284 of sensor 200. Sensor 200 may also include one or more o-rings 286 that are configured to engage with and seal to process adapter 280. While process adapter 280 is shown having a sanitary flange 290 for coupling to a corresponding flange, any suitable coupling mechanism can be used.

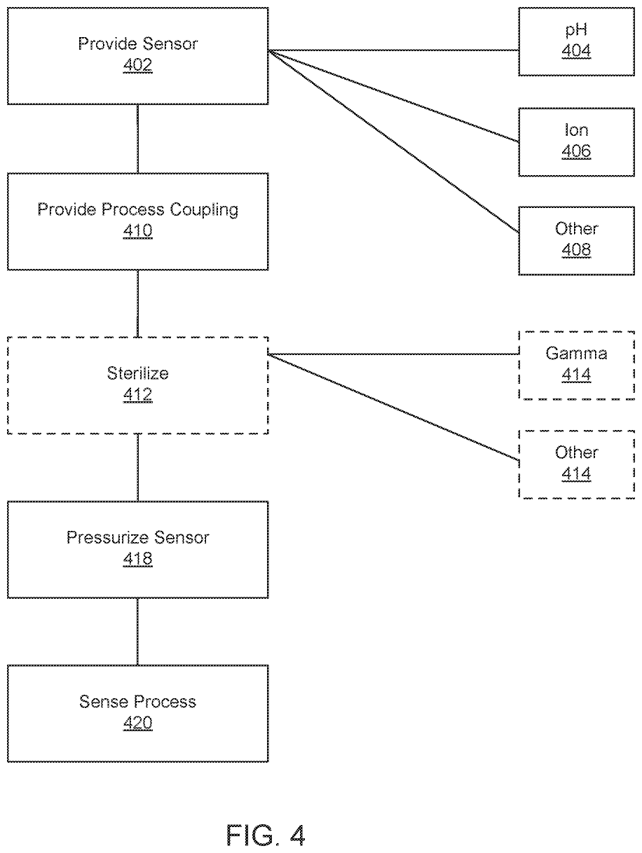

FIG. 4 is a flow diagram of a method of operating a single-use electrochemical analytical sensor in accordance with one embodiment. Method 400 begins at block 402 where a single-use electrochemical sensor is provided. The sensor may be a pH sensor 404, an ion sensor 406, or any other sensor 408 that includes an electrolyte that must flow into the process fluid to generate a sensor signal. At block 410, a process coupling is obtained. If the sensor is to be coupled to a downstream single-use process, the process coupler may be process coupler 280 (shown in FIG. 3B). However, the process coupler is generally specific to the process installation and is configured to locate the sensor in or suitably close to the process fluid to obtain a process variable signal. Next, at optional block 412, the sensor and the process coupling may be sterilized. This may be done using gamma irradiation 414, X-ray irradiation, or via other suitable methods 416. The sterilized sensor and/or process coupler may be packaged or otherwise maintained in the sterilized condition until called upon for use. When such use is required, block 418 executes, where the sensor is pressurized just prior to use. Such pressurization is preferably done via a manual operation of a knob or user-actuatable pressure activation mechanism, such as mechanism 204 (shown in FIG. 3B). Finally, at block 420, the pressurized sensor is used to sense the process fluid.

It can thus be seen, that a sensor and method are provided that facilitate long-term shelf life, since the sensor is not pressurized during storage. Then, just prior to operation, the sensor is pressurized, in order to allow accurate and precise operation in pressurized process fluid environments, such as downstream processing. Additionally, it is believed that the shelf life and product lifetime of a pH sensor can be extended by increasing viscosity of the reference electrolyte within the device. For example, a thick reference gel can be used for this purpose. Using a higher viscosity reference gel will lead to a longer service life. In addition, the introduction of the reference gel will reduce the internal pressure required for the sensor to perform well under high external process pressure.

Actuation of the piston can be done in several ways. In one embodiment, the spring is compressed during sensor assembly and the piston is locked in place by features in the cylinder body keeping it from pressurizing the system. When the piston cap is rotated 90 degrees the piston moves off the retaining features and provides the force to generate pressure in the system. Further, the actuated piston may also be locked in the actuated position by a locking mechanism.

In another embodiment the installer pushes or pulls the piston cap while features on the cylinder body retain the cap as the user turns it 90 degrees. Alternatively, the cap could be retained by snap features without rotation.

Note that the pressurization methods described herein not limited to only pH sensors, but can be applied to other potentiometric ion sensors in general. These ion sensors include but are not limited to potassium, sodium, chloride, and fluoride sensors, just to name a few. As long as the sensor reference electrode relies on the diffusion of the internal reference electrolyte through a porous junction material, it could be pressurized via the methods described above.

Although the present invention has been described with reference to preferred embodiments, workers skilled in the art will recognize that changes may be made in form and detail without departing from the spirit and scope of the invention. For example, while the description provided above illustrates the pressurization of the reference chamber in one particular manner, such pressurization can take a variety of forms. The sensor could include a spring member that is preloaded at the factory and that is released on-site to apply pressure to reference chamber. In another example, an unloaded spring member could be compressed via pushing on-site. In yet another example, an unloaded spring member could be compressed via pulling on-site. In still another example, an unloaded spring member could be compressed via a screw member on-site.

In another example, an unloaded spring member could be compressed via pushing and twisting on-site. In another example, an unloaded spring member could be compressed via pulling and twisting on-site.

What is claimed is:

1. A single-use electrochemical analytical sensor comprising:
a sensing electrode configured to contact process fluid;
a reference chamber containing an electrolyte;
a reference electrode disposed in the electrolyte;
a reference junction configured to contact the process fluid, the reference junction being further configured to generate a flow of electrolyte into the process fluid; and
wherein the reference chamber is configured to be stored in a depressurized state and then pressurized prior to operation.

2. The single-use electrochemical analytical sensor of claim 1, and further comprising a pressure activation mechanism that is configured to generate pressure within the reference chamber, when activated.

3. The single-use electrochemical analytical sensor of claim 2, wherein the pressure activation mechanism includes:
a first movable piston disposed to generate pressure within the reference chamber with movement of the first movable piston.

4. The single-use electrochemical analytical sensor of claim 3, and further comprising an o-ring seal disposed about the first movable piston.

5. The single-use electrochemical analytical sensor of claim 3, and further comprising a second movable piston, the second movable piston being spaced from the first movable piston by a spring.

6. The single-use electrochemical analytical sensor of claim 5, and further comprising a mechanical latching mechanism to lock the second movable piston in the pressurized position.

7. The single-use electrochemical analytical sensor of claim 5, wherein the spring is configured to move the first movable piston away from the second movable piston as the electrolyte flows into the process fluid to maintain pressure in the electrolyte.

8. The single-use electrochemical analytical sensor of claim 7, wherein a sidewall of the sensor containing the first movable piston is constructed from a material that allows a position of the piston to be viewed through the sidewall.

9. The single-use electrochemical analytical sensor of claim 1, wherein the electrolyte is a gel.

10. The single-use electrochemical analytical sensor of claim 1, wherein the reference chamber is configured to be pressurized to 90 psi.

11. The single-use electrochemical analytical sensor of claim 1, wherein the sensing electrode is a pH glass electrode.

12. The single-use electrochemical analytical sensor of claim 1, wherein the reference junction is a porous disc.

13. The single-use electrochemical analytical sensor of claim 12, wherein the disc is constructed of a material selected from the group consisting of ceramic and polymer.

14. The single-use electrochemical sensor of claim 1, and further comprising a downstream flowthrough process coupling operably coupled the sensor.

15. The single-use electrochemical sensor of claim 14, wherein at least one of the sensor and the process coupling are sterilized.

16. A method of operating a single-use electrochemical analytical sensor, the method comprising:
providing a single-use electrochemical analytical sensor;
providing a process coupling which is accessible to a process fluid;
pressurizing a reference chamber of the single-use electrochemical sensor; and
using the pressurized single-use electrochemical sensor to sense a characteristic of a process fluid.

17. The method of claim 16, wherein pressurizing the reference chamber is achieved by one of compressed gas or a mechanical hydraulic system, and wherein the internal reference chamber pressure is between 0 and 100 psi.

18. The method of claim 16, and further comprising sterilizing at least one of the single-use electrochemical sensor and the process coupling prior to pressurizing the reference chamber.

19. The method of claim 18, wherein the sterilizing process employs at east one of gamma radiation and X-ray radiation.

20. The method of claim 16, wherein the single-use electrochemical sensor is a pH sensor.
